(19) United States
(12) Patent Application Publication
(10) Pub. No.: US 2014/0351369 A1
(43) Pub. Date: Nov. 27, 2014

(54) DEVICE FOR TWO-WAY WIRELESS DATA TRANSMISSION

(71) Applicant: ADD INC. LIMITED, Hong Kong (CN)

(72) Inventor: Shu On Frederick MAN, Hong Kong (CN)

(73) Assignee: ADD INC. LIMITED, Hong Kong (CN)

(21) Appl. No.: 13/900,498

(22) Filed: May 22, 2013

(51) Int. Cl. H04W 4/00

(52) U.S. Cl. CPC H04W 4/005
USPC 709/217

(57) ABSTRACT

The present invention discloses a device for two-way wireless data transmission comprising a display, and a wireless communication module for wireless communication between two devices for two-way data transmission; and a control chip connected electrically with wireless communication module, which is used for controlling two-way data exchange between two devices for two-way data transmission. The new device for two-way wireless data transmission of the invention, although under the closed environment, can wirelessly achieve two-way data transmission without complicated matching process between two devices in prior art, and can speed up data exchange in two devices, such as smart phone, MP3 of MP4.

### TECHNICAL FIELD

The present invention generally relates to the field of data transmission, and more particularly, to a device that can exchange personal data bi-directionally.

### BACKGROUND OF THE INVENTION

Nowadays information transmission technology are well developed, which can be used in various personal electric products, for example, data exchange between smart terminals and personal computers. For wire communication, a data access can be used to synchronize data between two devices. But for wireless communication, only one-way data transmission is existed in existing transmission technology. And before data transmission, connection of the two devices is needed, which would lead to complicated process and longer time for data transmission.

Several publications disclose some data transmission technologies to prior art, such as Chinese patent application CN101414453A discloses a system for two-way data transmission and a method for same, a display device and a microcomputer, which utilizes the following technical solution: connecting by wire or wirelessly two devices first; digitally processing the input image to obtain output image information; then exchanging the obtained image information. The inventive point of this invention is to specifically process the input information, which needs complicated compute and longer time, then to exchange the processed data. This invention has disadvantages that the devices cannot exchange all the information in the devices.

Therefore, there is a need to improve the device for data transmission in existing technology so that users can easily and conveniently transfer Data in the various devices without any complicated connection and compute process, if desired.

### SUMMARY OF THE INVENTION

This invention responds to the above need of a new device for two-way wireless data transmission, which can wirelessly achieve two-way data transmission without complicated matching process between two devices, and can speed up data exchange between two devices, such as smart phone, MP3 or MP4, even under the closed environment.

To achieve the above objects, the following technical solutions are adopted:

a device for two-way wireless data transmission comprising a display, wherein the device further comprises:

a wireless communication module for wirelessly communicating with another device for two-way wireless data transmission; and

a control chip connected electrically with the wireless communication module, which is used for controlling two-way data exchange between two devices for two-way data transmission.

According to the device for two-way wireless data transmission in the invention, the control chip comprises:

a user creating module for creating an image of a user who needs to exchange data in the device for two-way wireless data transmission;

an image matching module for receiving and selecting an image to match in the device for two-way wireless data transmission; and

a synchronization module for controlling the two-way data transmission synchronously between the matched users if the images are well matched.

According to the device for two-way wireless data transmission in the invention, the control chip may comprise a user's image saving module for saving images that have been matched before.

According to the device for two-way wireless data transmission, the control chip further comprises a brightness control module for controlling the lightness of the display of the device for two-way wireless data transmission.

According to the device for two-way wireless data transmission, the control chip further comprises a sleep mode control module for controlling the sleep time of the device for two-way wireless data transmission.

According to the device for two-way wireless data transmission, the control chip further comprises a language control module for adjusting the language of the device for two-way wireless data transmission.

According to the device for two-way wireless data transmission, the control chip further comprises a voice control module for controlling the voice signal of the device for two-way wireless data transmission.

According to the device for two-way wireless data transmission, the wireless communication module is 2.4 G module or Bluetooth module.

According to the device for two-way wireless data transmission, the device for two-way wireless data transmission is selected from the group consisting of electric watch, mobile phone, MP3 or MP4.

According to the device for two-way wireless data transmission, the control chip has a size of 14.3 mm×11.2 mm, and the control chip is packaged to include 8 pins, in which the first pin is ground terminal, the second pin is voltage terminal, the third and the fourth pin are digital outputting terminals, and the fifth, sixth, seventh and eighth pins are digital inputting terminals.

Accordingly, the device for two-way wireless data transmission of the invention is different from the device in prior art, because this device utilizes a control chip to wirelessly and accurately control the two-way data transmission without complicated matching process. In addition, this device can also achieve two-way data transmission under closed environment.

### BRIEF DESCRIPTION OF THE DRAWINGS

The features of the present invention may be clearly set forth with reference to the accompanying drawings. The invention, together with the advantages thereof may be best understood by reference to the following description taken in conjunction with the accompany drawings, wherein like reference signs identify like elements, and wherein:

FIG. 1 is a schematic diagram view of the device for two-way wireless data transmission, according to the present invention;

FIG. 2 is a schematic diagram view of the control chip of the device for two-way wireless data transmission, according to the present invention; and

FIG. 3 is schematic view of the external package of the device for two-way wireless data transmission, according to the present invention.

### DETAILED DESCRIPTION OF THE INVENTION

The structure and function of the device for two-way wireless data transmission of the invention will be explained in detail with reference to the accompany drawings. The description and explanatory embodiments herein are merely used to set forth the present invention, not to limit the invention.

According to the present invention, a device 100 for two-way wireless data transmission is provided which is easy to satisfy the requirement of wireless and two-way data transmission, without complicated matching process with other devices.

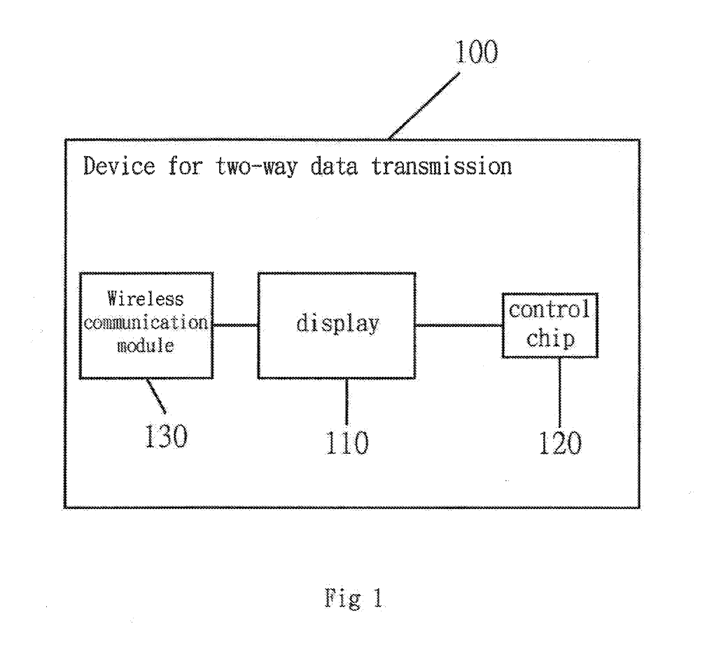

As shown in FIG. 1, a device 100 for two-way wireless data transmission comprises a display 110 disposed therein; a control chip 120 electrically connected with the display 110, which is disposed in the device 100 and is used for controlling two-way data transmission between the device 100 and another device; and a wireless communication module 130 for wirelessly communicating with another device. Using the control chips 120 and wireless communication modules 130, the information in the device 100 can be exchanged bi-directionally and instantly with another device, even under the closed environment.

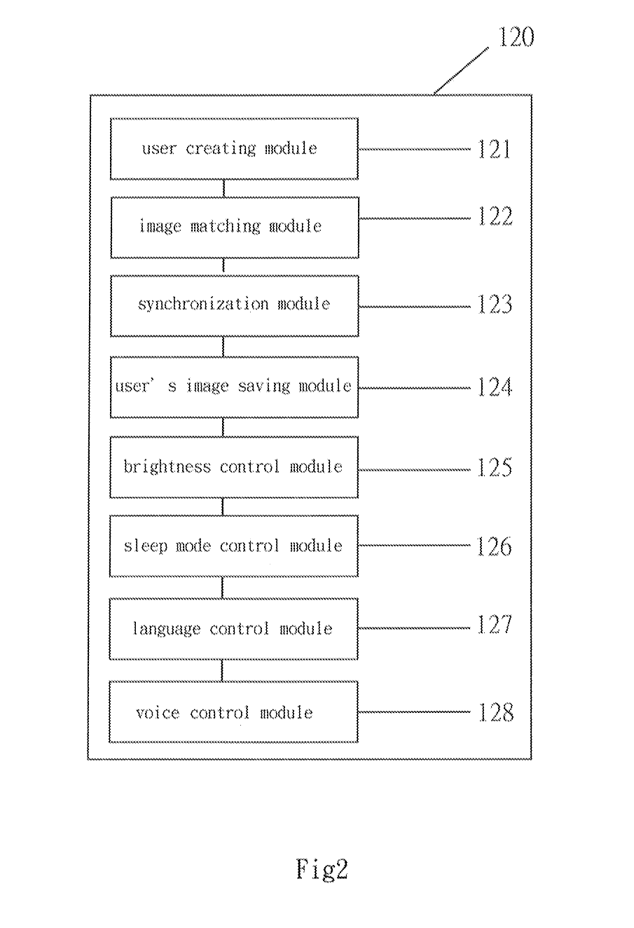

As illustrated in FIG. 2, the control chip 120 comprises a user creating module 121 for creating an image of the user who needs to exchange data in the device 100 for two-way data transmission; an image matching module 122 for receiving and selecting to match the images of users who needs to exchange data; and a synchronization module 123 for controlling the two-way data transmission synchronously between the matched devices if the images therein are well matched. The created image can include a lot of information, such as user's name, age, telephone number, email, address, which are some personal information that any other person needs to obtain. Thus, each created image can represent different individual information. When one device 100 for two-way wireless data transmission is wirelessly connected with another device, the image matching module 122 may be started to match the image created in the devices. If the two images are fully matched, the synchronization module 123 is immediately started, and the personal information underlying the images such as user's name, age and telephone number, can be transmitted bi-directionally so as to achieve instant data synchronization between two devices without complicated matching process.

According to the present invention, the control chip 120 may preferably further comprise a user saving module 124, which is used to save the user's image and his/her personal information created before. Thus, when any updated and/or amended information in the device needs to exchange, it is not necessary to re-create the user's image and personal information, which can save time and further simplify the operation process.

According to the present invention, the control chip 120 may preferably further comprise a brightness control module 125, which is used for controlling the brightness of the display 110 of the device 100 for two-way data transmission. This module can adjust brightness of the display 110 according to the environment, which can result in electricity-saving.

According to the present invention, the control chip 120 may preferably further comprise a sleep mode control module 126, which is used to control the time that the device 100 enters into the sleep mode. More specifically, the above time can be pre-set in the device 100, for example, 5 seconds, 10 seconds, or 300 seconds, according to the user's requirement and desire. When the user want to change the time, the sleep mode control module 126 can be started to adjust the time.

According to the present invention, the control chip 120 may preferably further comprise a language control module 127, which is used to change the language used in the device 100. The user can change the language displayed on the display 110 of the device 100 to the native language, for example, Chinese, English, Japanese or other language can be changed according to the user's instant requirement.

According to the present invention, the control chip 120 may preferably further comprise a voice control module 128, which is used for controlling the volume of the device 100. By using software installed in the device 100 or a button located on the device 100, the volume of the device 100 can be increased or decreased depending on the requirements of the user.

In one embodiment of the invention, the said device 100 for two-way wireless data transmission is a mobile phone, such as smart phone like iphone and smart phones installed android system therein. In another embodiment of the invention, the said device 100 for two-way wireless data transmission is an electric watch. In another embodiment of the invention, the said device 100 for two-way wireless data transmission is MP3. In another embodiment of the invention, the said device 100 for two-way wireless data transmission is MP4.

In one embodiment of the invention, the said wireless communication module 130 is WI-FI module. In another embodiment of the invention, the said wireless communication module 130 is Bluetooth module. By using this Bluetooth module, data can be transmitted under the closed environment, without using any wireless network, such as 2 G, 2.5 G, 3 G or 4 G. Thus, the object of two-way data transmission of the invention can be well achieved.

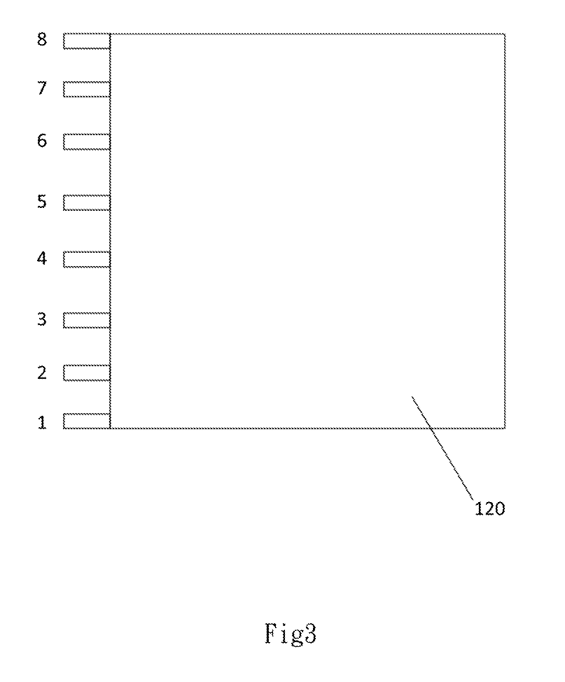

As shown in FIG. 3, according to one embodiment of the invention, the control chip 120 of the invention preferably has a size of 14.3 mm×11.2 mm. The control chip 120 comprises a grain in the control chip 120 and at least 8 pins on the external package of the control chip 120, is which the first pin 1 is a ground terminal, the second 2 pin is a voltage terminal, the third 3 and the fourth 4 pins are digital outputting terminals, and the fifth 5, sixth 6, seventh 7 and eighth 8 pins are digital outputting terminals.

It should be understood that the control chip 120 may have different sizes and different external packages depending on the device in which the control chip 120 is disposed, while the function modules in the control chip 120 may still remain unchanged. That is to say, all the modules above are necessary for the device 100 for two-way wireless data transmission.

The device 100 for two-way wireless data transmission of this invention may allow users to have an alternative option in relation to data transmission, which not only can change the traditional data transmission mode that is very complicated, but also can easily transfer data bi-directionally. Further this device 100 of the present invention is not limited by the environment.

While a particular embodiment of the invention has been shown and described, it will be obvious to those skilled in the art that changes and modifications cans be made without departing from the true spirit and scope of the invention. It should be appreciated that all the embodiments of the present invention described above are illustrative only, and all the changes and modifications made by those skilled in the art are covered by the appended claims.

What is claimed is:

1. A device for two-way wireless data transmission comprising a display, characterized in that the device further comprises:
a wireless communication module for wirelessly communicating with another Device for two-way wireless data transmission; and
a control chip connected electrically with the wireless communication module, which is used for controlling two-way data exchange between two devices for two-way data transmission.

2. The device for two-way wireless data transmission according to claim 1, characterized in that the control chip comprises:
a user creating module for creating an image of a user who needs to exchange data in the device for two-way wireless data transmission;
an image matching module for receiving and selecting an image to match in the device for two-way wireless data transmission; and
a synchronization module for controlling the two-way data transmission synchronously between the matched users if the images are well matched.

3. The device for two-way wireless data transmission according to claim 2, characterized in that the control chip further comprises a user's image saving module for saving the image that has been matched before.

4. The device for two-way wireless data transmission according to claim 2, characterized in that the control chip further comprises a brightness control module for controlling the brightness of the display of the device for two-way wireless data transmission.

5. The device for two-way wireless data transmission according to claim 2, characterized in that the control chip further comprises a sleep mode control module for controlling the sleep time of the device for two-way wireless data transmission.

6. The device for two-way wireless data transmission according to claim 2, characterized in that the control chip further comprises a language control module for adjusting the language of the device for two-way wireless data transmission.

7. The device for two-way wireless data transmission according to claim 2, characterized in that the control chip further comprises a voice control module for controlling volume of the device for two-way wireless data transmission.

8. The device the two-way wireless data transmission according to claim 1, characterized in that the wireless communication module is 2.4 G module or Bluetooth module.

9. The device for two-way wireless data transmission according to claim 1, characterized in that the Device for two-way wireless data transmission is selected from the group consisting of electric watch, mobile phone, MP3 or MP4.

10. The device for two-way wireless data transmission according to claim 1, characterized in that the control chip has a size of 14.3 mm×11.2 mm, and the control chip is packaged to include 8 pins, in which the first pin is a ground terminal, the second pin is a voltage terminal, the third and the fourth pins are digital outputting terminals, and the fifth, sixth, seventh and eighth pins are digital inputting terminals.
